(19) United States
(12) Patent Application Publication
(10) Pub. No.: US 2007/0006897 A1
(43) Pub. Date: Jan. 11, 2007

(54) Paint washing apparatus

(76) Inventors: Vernon Antonio Sarri, Morningside (AU); Mark Taylor, Wakerley (AU)

Correspondence Address: STREETS & STEELE, 13831 NORTHWEST FREEWAY, SUITE 355, HOUSTON, TX, 77040, US

(21) Appl. No.: 11/281,173

(22) Filed: Nov. 17, 2005

(30) Foreign Application Priority Data
Jul. 11, 2005 (AU) AU2005203010

(51) Int. Cl. B08B 7/04; B08B 9/00; B08B 3/04; B08B 3/00

(52) U.S. Cl. 134/10; 134/166 C; 134/104.2; 134/22.1

(57) ABSTRACT

A paint washing apparatus for washing paint equipment includes a holder for holding one or more pieces of paint equipment to be washed. There is also provided a container for collecting wash water and in which a flocculant can be provided to flocculate paint in the wash water. In addition, the paint washing apparatus includes a filter arrangement for filtering flocculated paint from the wash water. Methods for washing paint equipment are also disclosed.

### TECHNICAL FIELD

The present invention relates to a paint washing apparatus for washing paint equipment such as, for example, paint brushes, paint rollers, spray gun nozzles and other spray gun fittings. The present invention also relates to a method for washing paint equipment.

### BACKGROUND

Paint equipment including paint brushes and rollers are commonly used for painting. Once painting has been completed, the paint equipment is typically washed with a hose in a sink so that the paint equipment can be used again at a later stage. The wash water from the paint equipment drains from the sink and into the sewer, which is not only hazardous to the environment but also wasteful of water.

In many jurisdictions, it is illegal to allow wash water to pass into sewers and doing so can result in a monetary fine. Accordingly, professional painters who generate a relatively large amount of wash water often employ third parties to dispose of their wash water in an environmentally friendly manner, which can be quite involved and expensive. There is a need for an alternative technique which is suitable for painters, and professional painters in particular, to dispose of paint wash water.

Accordingly, it is an object of the present invention to provide a technique which enables painters to dispose of paint wash water in an environmentally responsible manner.

### SUMMARY OF THE INVENTION

According to one aspect of the present invention, there is provided a paint washing apparatus for washing paint equipment, the paint washing apparatus including:

a holder for holding one or more pieces of paint equipment to be washed;

a container for collecting wash water and in which a flocculant can be provided to flocculate paint in the wash water; and

a filter arrangement for filtering flocculated paint from the wash water.

Preferably, the filter arrangement includes:

a first outlet defined at the base of the container through which flocculated paint sediment can exit the container; and

a first filter in fluid communication with the first outlet and for filtering flocculated paint from the wash water. Even more preferably, the first outlet is defined in a side wall of the container.

Even more preferably, the filter arrangement includes:

a second outlet defined in the container at a height above the first outlet and for draining wash water including suspended flocculated paint from the container; and

a second filter in fluid communication with the second outlet and for filtering flocculated paint from the wash water.

The paint washing apparatus may include a pump for pumping flocculated paint sediment from the container to the first filter.

In one embodiment, paint washing apparatus further includes a combiner for combining outlets of the first and second filters. The paint washing apparatus may further include a non-return valve in fluid communication with the combiner for impeding backflow of the filtered wash water. The paint washing apparatus may further include a third filter in fluid communication with the combiner. The non-return valve may be located between the third filter and the combiner.

In one embodiment, the holder includes another container for containing the paint equipment to be washed. Preferably, the other container includes a basin or a wire basket. Alternatively, the holder may include a fastener for fastening paint equipment within or above the container.

The paint washing apparatus may further include a frame for locating the containers in register with one another. The frame may include a cage for encircling the containers. The frame may also include a cradle in which the other container can rest. The frame may also include a support fast with the cage and upon which the container can rest.

The paint washing apparatus may further include a water tap and a hose for attaching to the tap for washing the paint equipment.

According to a further aspect of the present invention, there is provided a paint washing apparatus for paint equipment, the paint washing apparatus including:

a holder for holding a plurality of pieces of paint equipment to be washed;

a container for collecting wash water from the holder and in which a flocculant can be provided to flocculate paint in the wash water; and

a remover for removing flocculated paint from the container.

In one embodiment, the container is formed by a portion of a wheeled bin.

Preferably, wash water passes through the holder during washing. Even more preferably, the holder includes a basin in which the paint equipment can be washed.

The remover may include an outlet defined in the container through which flocculated paint can exit the container. The outlet may be located at the base of the container so that flocculated paint sediment can exit the container. The remover may include a filter arranged in fluid communication with the outlet for filtering flocculated paint from the wash water.

Alternatively, the remover may include a sieve.

The remover may include another outlet at a height above the first outlet for draining wash water including suspended flocculated paint from the container. The remover may also include another filter in fluid communication with the other outlet and for filtering flocculated paint from the wash water.

According to a further aspect of the present invention, there is provided a method for washing one or more pieces of paint equipment, the method including the steps of:

washing paint equipment to produce wash water;

combining a flocculant with the wash water to flocculate the paint in the wash water; and

filtering flocculated paint from the wash water.

Preferably, between the steps of combining and filtering, the method further includes the step of:

agitating the solution of flocculant and wash water.

Even more preferably, the step of filtering occurs after flocculated paint settles to form sediment.

The step of filtering may include filtering flocculated paint which is suspended in the wash water from the wash water.

The step of filtering may include filtering flocculated paint sediment from the wash water.

According to a further aspect of the present invention, there is provided a kit for assembling the paint washing apparatus.

According to a further aspect of the present invention, there is provided a wheeled bin assembly including:

a wheeled bin; and

the paint washing apparatus.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1a is a plan view of a frame for a paint washing apparatus in accordance with a first embodiment of the present invention.

FIG. 1b is a side view of the frame of FIG. 1a.

FIG. 1c is an end view of the frame of FIG. 1a.

FIG. 2a is a plan view of a paint washing apparatus in accordance with the first embodiment of the present invention.

FIG. 2b is a side view of the paint washing apparatus of FIG. 2a.

FIG. 2c is an end view of the paint washing apparatus of FIG. 2a.

FIG. 3 is a fluid flow diagram showing wash water being removed from a holding tank of the paint washing apparatus of FIG. 2.

FIG. 4 is a flowchart showing a method for washing one or more pieces of paint equipment using the paint washing apparatus of FIG. 2.

FIG. 5a is a plan view of a wheeled bin assembly including a paint washing apparatus in accordance with a second embodiment of the present invention.

FIG. 5b is a left side view of the wheeled bin assembly of FIG. 2a.

FIG. 5c is a front end view of the wheeled bin assembly of FIG. 2a.

FIG. 5d is a right side view of the wheeled bin assembly of FIG. 2a.

FIG. 5e is a rear end view of the wheeled bin assembly of FIG. 2a.

FIG. 6 is a fluid flow diagram showing wash water being removed from a holding tank of the paint washing apparatus of FIG. 5.

### DETAILED DESCRIPTION OF PREFERRED EMBODIMENTS

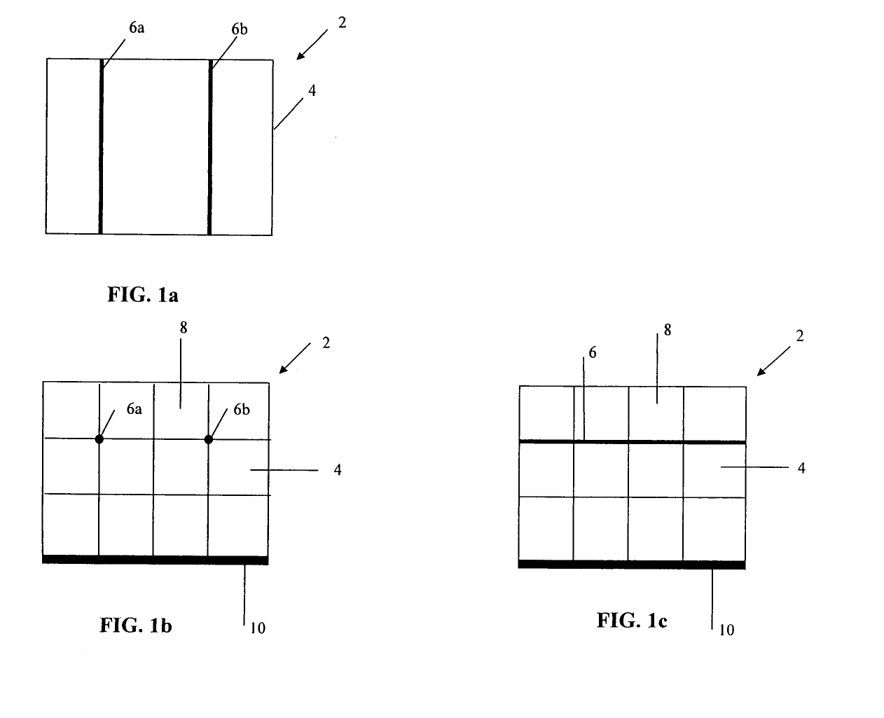

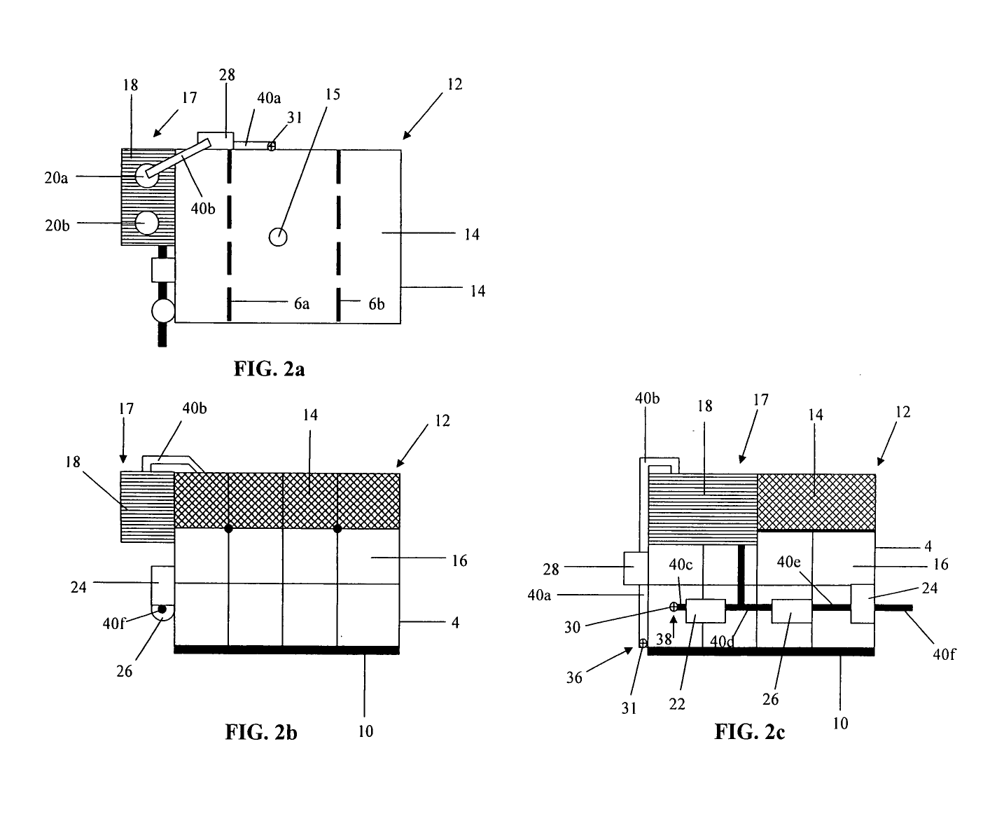

According to a first embodiment of the present invention, there is provided a metal frame 2 (shown in FIG. 1) which can be used to assemble a paint washing apparatus 12 for washing paint equipment. The assembled paint washing apparatus 12 including the frame 2 is shown in FIG. 2.

Returning to FIG. 1, the frame 2 includes a rectangular cage 4 which includes a plurality of horizontal and vertical metal rods. The cage 4 is fast with and encircles a rectangular planar support 10. A rectangular holding tank 16 can be located within the cage 4 so as to rest upon the support 10 (FIG. 2). As can best be seen in FIG. 1a, a pair of parallel support rods 6 are fastened to opposing sides of the cage 4. The support rods 6 are fastened above the holding tank 16 and, together with the top portion of the cage 4, form a cradle 8 in which a basin 14 can be rested (FIG. 2). In this manner, the frame 2 serves to locate the basin 14 above and in register with the holding tank 16.

Referring to FIG. 2, the paint washing apparatus 12 includes the frame 2, the basin 14 (i.e. holder) for holding paint equipment to be washed and which is located in the cradle 8, and the holding tank 16 (i.e. container) which is located beneath the basin 4 in the lower portion of the frame 2 and collects wash water which drains through a drain 15 of the basin 14. A flocculant can be provided to flocculate paint in wash water contained within the holding tank 16. The paint washing apparatus 12 further includes a filter arrangement (i.e. remover) for filtering flocculated paint from the wash water and removing the flocculated paint from holding tank 16.

The filter arrangement includes a sludge filter 17 which is mounted to a side of the cage 4. The sludge filter 17 includes a rectangular filter tank 18 to which a pair of filter bags 20 having a filtration rating of 5μ are releasably fastened. A lower outlet 36 is defined in a side wall of the base of the holding tank 16 and includes a sludge tap 31. A first pipe (or hose) 40a is connected between the sludge tap 31 and an inlet of a hand pump 28 and, in turn, a second pipe 40b is attached to an outlet of the hand pump 28 and drains into a filter bag 20a. In use, a user actuates the hand pump 28 and flocculated paint sediment at the base of the holding tank 16, exits the holding tank 16 and passes through lower outlet 36, sludge tap 31, pipe 40a, pump 28, pipe 40b, and into filter bag 20a respectively. Wash water passes through the filter bag 20a and into filter tank 18 whereas flocculated paint material larger that 5μ is retained in the filter bag 20a. The second filter bag 20b is an auxiliary filter bag which can be used if the first filter bag 20a becomes full or when collected flocculated paint in the first filter bag 20a is drying out.

The filter arrangement also includes an upper outlet 38 which includes a suspension tap 30 and is defined in the holding tank 16 at a height above the lower outlet 36. A third pipe 40c is interconnected between the suspension tap 30 and the inlet of a pre-filter 22 having a filtration rating of 50μ. A t-piece (fourth) pipe 40d interconnects the outlet of the pre-filter 22 and the inlet of a non-return valve 26. The t-piece pipe 40d also interconnects an outlet in the base of filter tank 18 to the inlet of the non-return valve 26. In this manner, the t-piece pipe 40d forms a combiner for combining the outlets of the sludge filter 17 and the pre-filter 22 into a single stream passing to the inlet of non-return valve 26. A fifth pipe 40e interconnects the outlet of non-return valve 26 to the inlet of an output filter 24 having a filtration rating of 5μ. A sixth pipe 40f is attached to the outlet of output filter 24 and has a free end which can be connected to a discharge hose which, in use, drains into an authorised discharge point (ADP) 42.

The paint washing apparatus 12 may further include a wash tap (not shown) which is mounted to the top of the frame 2. The wash tap may be attached with a supply hose to a fresh water supply, and a cleaning hose may be fastened to the wash tap for hand washing paint equipment located in the basin 14.

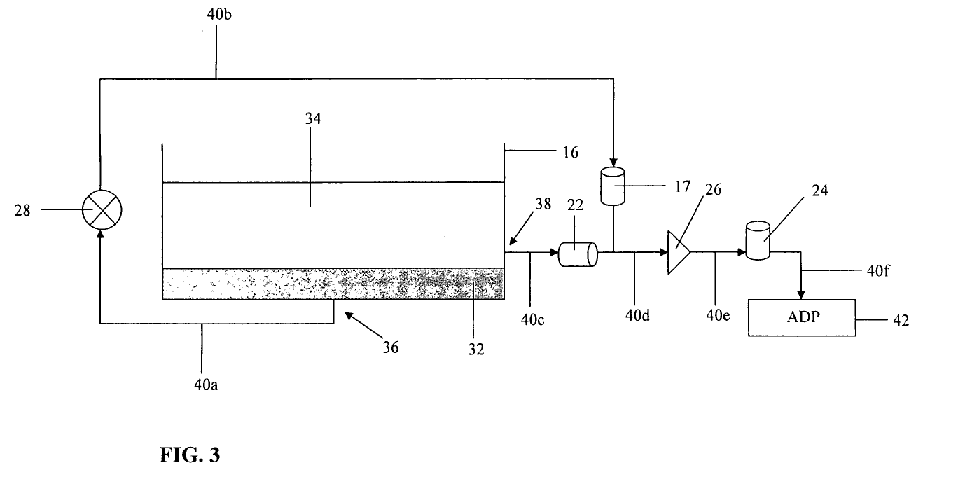

Referring to FIG. 3, it will be appreciated that the filter arrangement defines two respective filtration paths of the wash water 34 from the holding tank 16 to the ADP 42. A first fluid path is defined by the first outlet 36, first pipe 40a, pump 28, second pipe 40b, sludge filter 17, t-piece pipe 40d, non-return valve 26, fifth pipe 40e, output filter 24, and sixth pipe 40f respectively. A second fluid communication path is defined by the second outlet 38, pre-filter 22, t-piece pipe 40d, non-return valve 26, fifth pipe 40e, output filter 24, and sixth pipe 40f respectively.

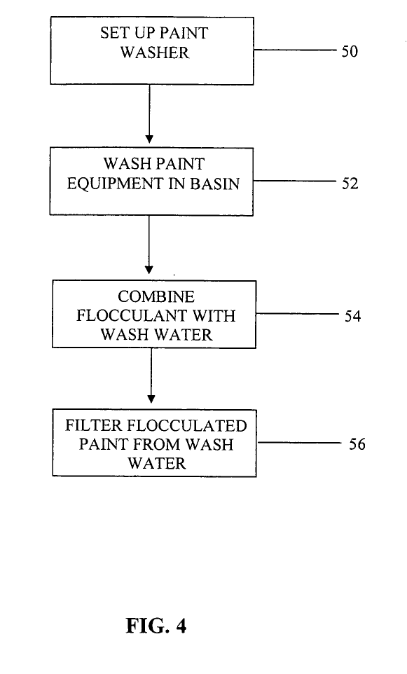

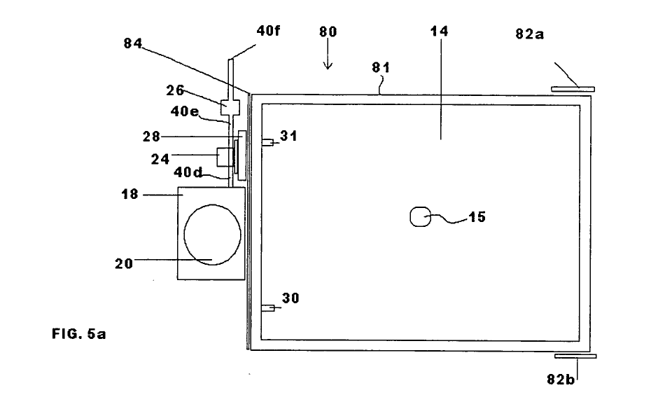

A method for washing paint equipment with the paint washing apparatus 12 will now be described with reference to FIG. 4.

In step 50, the paint washing apparatus 12 is set up for use by one or more users. The paint washing apparatus 12 is portable to site and may have castors (not shown) fastened to the support 10. Initially, the paint washing apparatus 12 is located on firm and level ground close to an authorised discharge point in a ADP 42. A discharge hose is connected between the sixth pipe 40f and arranged to drain into the ADP 42. The supply hose interconnects the wash tap with the fresh water supply, and the cleaning hose is fastened to the wash tap. The wash tap, suspension tap 30 and sludge tap 31 are all turned to the off position. One or more pieces of dirty paint equipment are placed in the basin 14 for washing.

Referring to step 52, the paint equipment is hand washed in basin 14 using the cleaning hose so as to produce wash water 34. A plug would not typically be inserted into drain 15 and the wash water 34 produced drains through drain 15 and into holding tank 16. After the paint equipment has been washed, the basin 14 and surrounding area can be further washed using the cleaning hose. If required, further fresh water is added to the holding tank 16 so that the tank 16 contains a desired volume of wash water 34 and a cover is then placed over the basin 14 to prevent any further washing until after the wash water 34 has been processed. In an alternative embodiment, the basin 14 may be instead be inverted to provide a cover for the holding tank 16.

Referring to step 54, a flocculant is combined with the wash water to flocculate the paint contained in the wash water 34. The resulting solution of flocculant and wash water can be agitated by manually stirring the solution with a paddle. In an alternative embodiment, a mechanical agitator may be provided within the holding tank 16. Over a period of hours, the paint contained within the wash water 34 flocculates and settles to form sediment (i.e. sludge) 32 at the base of holding tank 16 (FIG. 3). In practice, the volume of wash water 34 and concentration of flocculant will be selected so that, when all of the flocculated paint has settled to form the sediment 32, upper outlet 38 in holding tank 16 is located just above the sediment 32 layer. In practice, some flocculated paint will remain in suspension within the wash water 34.

Referring to step 56, the flocculated paint (suspended and sediment) is next filtered from the wash water 34. Firstly, the suspension tap 30 is opened so as to allow wash water 34, including and suspended flocculated paint, to drain into the ADP 42 via upper outlet 38, pre-filter 22, non-return valve 26 and output filter 24.

During this draining process, the sludge tap 31 can be opened and the sediment 32 at the base of holding tank 16 can then be pumped into the first filter bag 20a using the hand pump 28. In this manner, the sediment 32 can be transported to the filter bag 20a where it collects and becomes separated from the wash water 34. The wash water 34 then drains into tank 17 and passes into t-piece pipe 40d whereafter it also drains into the ADP 42 via non-return valve 26 and output filter 24. The non-return valve 26 impedes the wash water 34 which has exited filters 17 and 22 from returning through these filters in the event of a downstream blockage (e.g. if the ADP becomes blocked up). The filter bag 20a can be removed from filter tank 18, and the collected sludge can be emptied into a suitable container such as an empty paint drum to harden. Once hardened, the sludge can be disposed of with other industrial or household rubbish.

Once all of the wash water 34 has been removed from tank 16 and filtered, the basin 14 is removed from the cradle 8 and the holding tank 16 is further cleaned with fresh water using the cleaning hose. In turn, the fresh water collected in the holding tank 16 can pumped through lower outlet and drained through the upper outlet to remove any residual paint flocculant in the fluid paths. The filters 17, 22 and 24 can be cleaned or replaced as required.

The paint washing apparatus 12 enables painters to dispose of painting wash water 34 in an environmentally responsible manner whereby the paint is flocculated and then removed from the wash water 34. Once the flocculated paint is removed, the wash water is of a suitable standard to be drained into the ADP 42.

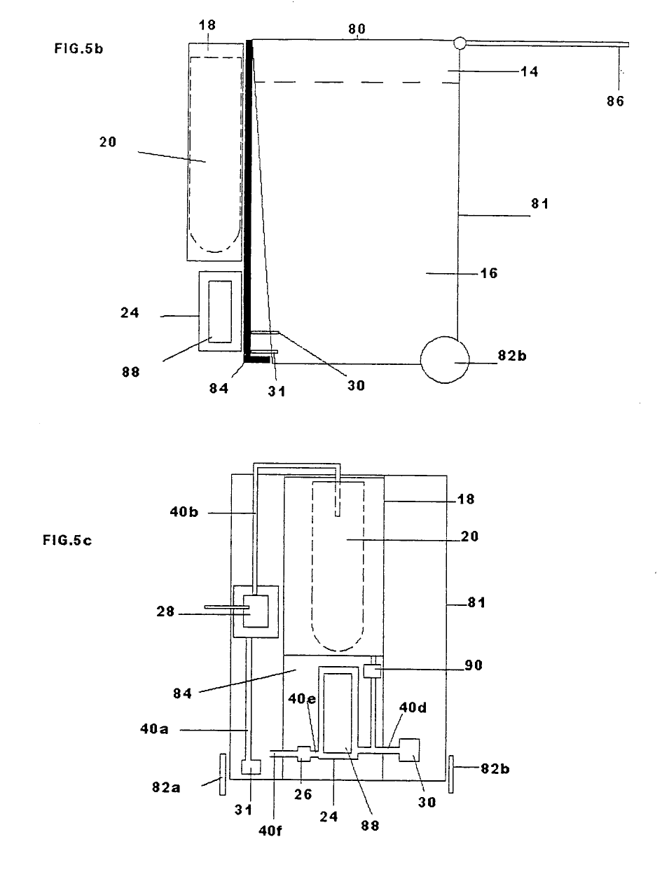

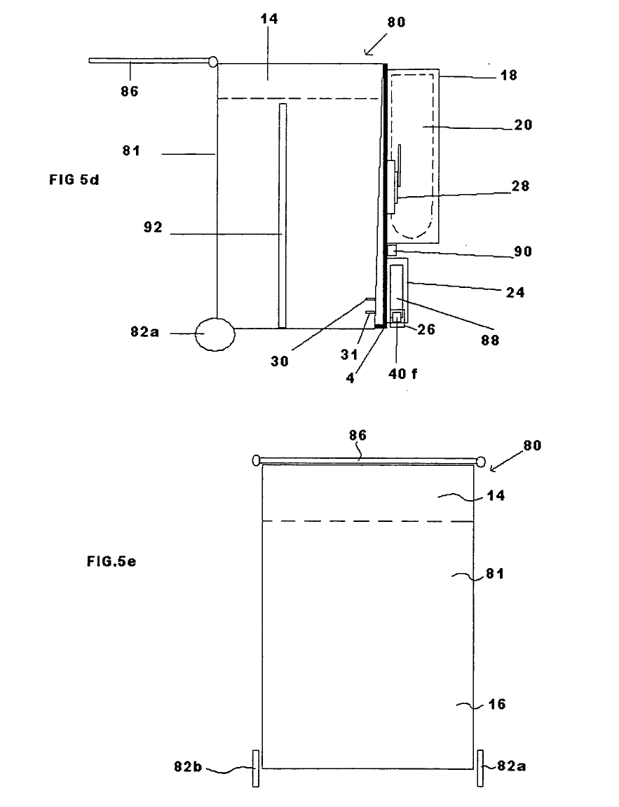

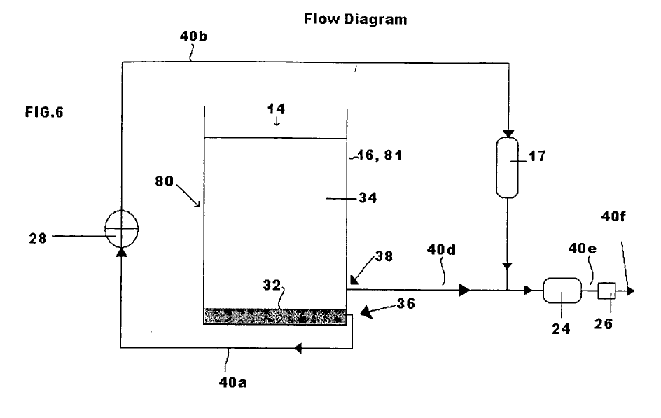

According to a second embodiment of the present invention, there is provided a wheeled bin assembly including a paint washing apparatus as shown in FIGS. 5 and 6. Like reference numerals in FIGS. 5 and 6 refer to like features already described in detail with respect to the first embodiment.

The wheeled bin assembly includes a wheeled bin 80. The wheeled bin 80 includes a container 81 which functions as a holding tank 16, a lid 86 which is pivotally attached to the container 81, and a pair of wheels 82a, 82b by which the container 81 can be transported by a user.

A mounting frame 84 is fastened to a wall of the wheeled bin 80. The mounting frame 84 provides a means by which the filter tank 18 and pump 28 can be mounted to the container 81 of the wheeled bin 80. The basin 14 is sized so as to be received and rested in the mouth of the container 81. The basin 14 may include one or more lips for resting on the edge of the container 81.

Referring to FIG. 5c, a tap 90 is provided between the filter tank 18 and the output filter 24. The output filter 24 may include a removable filter insert 88.

Referring to FIG. 5d, a sight gauge 92 may be provided for indicating the level of wash water 34 contained in the container 81. Typically, the sight gauge 92 would include graduations indicating the height above the floor of the container 81.

FIG. 6 is a fluid flow diagram showing wash water 34 being removed from the container 81 of the wheeled bin 80.

A person skilled in the art will appreciate that many embodiments and variations can be made without departing from the ambit of the present invention.

The paint washing apparatus may be provided in kit form.

According to the first embodiment described, there was provided a basin 14 for holding the paint equipment during washing. In yet another embodiment, an alternative holder could be used such as a wire basket in which the paint equipment can be placed, or a meshed grill on which the paint equipment can be placed. In yet another embodiment, the holder may include a fastener for fastening one or more pieces of paint equipment, such as brushes and rollers, either within or above the holding tank 16. The fastener may include a slot defined in a wall of the tank for holding a single piece of paint equipment.

In the first embodiment, the filtered wash water was drained into a ADP. In an alternative embodiment, the filtered wash water could instead be returned to the holding tank 16, either directly or indirectly.

In the first embodiment, a frame 2 was provided for locating the basin, and in particular the drain 15 in register with the holding tank 16. The frame further 2 included a cradle 8 for supporting the basin 14 above the holding tank 16. In an alternative embodiment, the mouth of the holding tank 16 may be shaped so as to accommodate, locate and support the base of the basin 14.

In the first embodiment, the remover included an outlet defined in the container. In an alternative embodiment, the remover may include a sieve or other like means for sieving flocculated paint from the wash water in the container. The paint washing apparatus may also include a hose for siphoning the wash water from the container.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims appropriately interpreted by those skilled in the art.

We claim:

1. A paint washing apparatus for washing paint equipment, the paint washing apparatus including:
a holder for holding one or more pieces of paint equipment to be washed;
a container for collecting wash water and in which a flocculant can be provided to flocculate paint in the wash water; and
a filter arrangement for filtering flocculated paint from the wash water.

2. A paint washing apparatus as claimed in claim 1, wherein the filter arrangement includes:
a first outlet defined at the base of the container through which flocculated paint sediment can exit the container; and
a first filter in fluid communication with the first outlet and for filtering flocculated paint from the wash water.

3. A paint washing apparatus as claimed in claim 2, wherein the first outlet is defined in a side wall of the container.

4. A paint washing apparatus as claimed in claim 2, wherein the filter arrangement includes:
a second outlet defined in the container at a height above the first outlet and for draining wash water including suspended flocculated paint from the container; and
a second filter in fluid communication with the second outlet and for filtering flocculated paint from the wash water.

5. A paint washing apparatus as claimed in claim 2, further including a pump for pumping flocculated paint sediment from the container to the first filter.

6. A paint washing apparatus as claimed in claim 4, further including a combiner for combining outlets of the first and second filters.

7. A paint washing apparatus as claimed in claim 6, further including a non-return valve in fluid communication with the combiner.

8. A paint washing apparatus as claimed in claim 6, further including a third filter in fluid communication with the combiner.

9. A paint washing apparatus as claimed in claim 8, further including a non-return valve located between the third filter and the combiner.

10. A paint washing apparatus as claimed in claim 1, wherein the holder includes another container for containing the paint equipment to be washed.

11. A paint washing apparatus as claimed in claim 10, wherein the other container includes a basin.

12. A paint washing apparatus as claimed in claim 10, further including a frame for locating the containers in register with one another.

13. A paint washing apparatus as claimed in claim 12, wherein the frame includes a cage for encircling the containers.

14. A paint washing apparatus as claimed in claim 10, wherein the frame includes a cradle in which the other container can rest.

15. A paint washing apparatus as claimed in claim 1, further including a supply tap for supplying water to wash the paint equipment.

16. A paint washing apparatus for paint equipment, the paint washing apparatus including:
a holder for holding a plurality of pieces of paint equipment to be washed;
a container for collecting wash water from the holder and in which a flocculant can be provided to flocculate paint in the wash water; and
a remover for removing flocculated paint from the container.

17. A paint washing apparatus as claimed in claim 16 wherein, during washing, wash water passes through the holder.

18. A paint washing apparatus as claimed in claim 16, wherein the holder includes a basin in which the paint equipment can be washed.

19. A paint washing apparatus as claimed in claim 16, wherein the remover includes an outlet defined in the container through which flocculated paint can exit the container.

20. A paint washing apparatus as claimed in claim 19, wherein the outlet is located at the base of the container.

21. A paint washing apparatus as claimed in claim 20, wherein the remover includes a filter arranged in fluid communication with the outlet.

22. A paint washing apparatus as claimed in claim 19, wherein the remover includes another outlet at a height above the first outlet.

23. A method for washing one or more pieces of paint equipment, the method including the steps of:
washing paint equipment to produce wash water;
combining a flocculant with the wash water to flocculate the paint in the wash water; and
filtering flocculated paint from the wash water.

24. A method as claimed in claim 23 wherein, between the steps of combining and filtering, the method further includes the step of:
agitating the solution of flocculant and wash water.

25. A method as claimed in claim 23, wherein the step of filtering occurs after flocculated paint settles to form sediment.

26. A method as claimed in claim 23, wherein the step of filtering includes filtering flocculated paint which is suspended in the wash water from the wash water.

27. A method as claimed in claim 23, wherein the step of filtering includes filtering flocculated paint sediment from the wash water.

28. A wheeled bin assembly including:
a wheeled bin; and
a paint washing apparatus as claimed in claim 1.

29. A paint washing apparatus as claimed in claim 1, wherein the container is formed by a portion of a wheeled bin.

30. A kit for assembling a paint washing apparatus as claimed in claim 1.
